(19) United States
(12) Patent Application Publication
(10) Pub. No.: US 2023/0163361 A1
(43) Pub. Date: May 25, 2023

(54) ELECTROLYTIC SOLUTION AND LITHIUM-ION SECONDARY BATTERY

(71) Applicants: HONDA MOTOR CO., LTD., Tokyo (JP); SAITAMA PREFECTURE, Saitama (JP)

(72) Inventors: Hiroshi OGASA, Saitama (JP); Hideki KURIHARA, Saitama (JP)

(21) Appl. No.: 18/058,734

(22) Filed: Nov. 24, 2022

(30) Foreign Application Priority Data
Nov. 25, 2021 (JP) 2021-191061

(51) Int. Cl. H01M 10/0569; H01M 10/0525; H01M 10/0567

(52) U.S. Cl. CPC H01M 10/0569; H01M 10/0525; H01M 10/0567; H01M 2300/0037

(57) ABSTRACT

There is provided an electrolytic solution including magnesium fluoride, lithium salt, a first solvent, and a second solvent, the first solvent having a dielectric constant of less than 10, and the second solvent having a dielectric constant of more than 50.

This application is based on and claims the benefit of priority from Japanese Patent Application 2021-191061, filed on 25 Nov. 2021, the content of which is incorporated herein by reference.

### BACKGROUND OF THE INVENTION

### Field of the Invention

The present invention relates to an electrolytic solution and a lithium-ion secondary battery.

### Related Art

In view of climate-related disasters, in order to reduce CO₂, interest in electric vehicles is growing, and use of lithium-ion secondary batteries is being considered also for in-vehicle applications. Furthermore, when the size and weight of an entire system of an electric vehicle are reduced, an energy efficiency can be improved.

An example of a known lithium-ion secondary battery is a lithium-ion secondary battery including a positive electrode current collector, a positive electrode material mixture layer, a separator, a negative electrode material mixture layer, and a negative electrode current collector, which are sequentially stacked, and in which the separator is filled with an electrolytic solution. In a lithium-ion secondary battery, an SEI (solid electrolyte interface) coating film is formed on an interface between an electrode and an electrolytic solution during charge and discharge. Therefore, oxidation-reduction potential of lithium is low, but continuous decomposition of the electrolytic solution can be suppressed.

Patent Document 1 describes an electrolytic solution including lithium hexafluorophosphate (LiPF₆) dissolved in a mixed solvent including ethylene carbonate (EC), dimethyl carbonate (DMC), and ethyl methyl carbonate (EMC).

Patent Document 1: Japanese Unexamined Patent Application, Publication No. 2016-149211

### SUMMARY OF THE INVENTION

However, initial capacity and a capacity retention rate during high-rate charge and during high-rate discharge are deteriorated, and a high-rate battery cannot be achieved.

The present invention has an object to provide an electrolytic solution capable of improving initial capacity and a capacity retention rate of a lithium-ion secondary battery during high-rate charge and during high-rate discharge.

One aspect of the present invention is an electrolytic solution including magnesium fluoride, lithium salt, a first solvent, and a second solvent, the first solvent having a permittivity of less than 10, the second solvent having a permittivity of more than 50.

In the above-mentioned electrolytic solution, a volume ratio of the second solvent to a total amount of the first solvent and the second solvent may be 6% or more and 12% or less.

In the above-mentioned electrolytic solution, a content of the magnesium fluoride may be 0.3% by mass or more and 1.0% by mass or less.

The first solvent may be one or more types selected from the group consisting of dimethyl carbonate, diethyl carbonate, and ethyl methyl carbonate.

The second solvent may be one or more types selected from the group consisting of ethylene carbonate, propylene carbonate, and vinylene carbonate.

Another aspect of the present invention is a lithium-ion secondary battery including the electrolytic solution mentioned above.

The present invention can provide an electrolytic solution capable of improving initial capacity and a capacity retention rate of a lithium-ion secondary battery during high-rate charge and during high-rate discharge.

### BRIEF DESCRIPTION OF THE DRAWINGS

FIG. 1 is a graph showing initial charge/discharge curves during high-rate discharge of a lithium-ion secondary battery including an electrolytic solution according to Example 1;

FIG. 2 is a graph showing initial charge/discharge curves during high-rate discharge of a lithium-ion secondary battery including an electrolytic solution according to Comparative Example 1;

FIG. 3 is a graph showing cycle characteristics during high-rate discharge of the lithium-ion secondary battery including the electrolytic solution according to Example 1;

FIG. 4 is a graph showing cycle characteristics during high-rate discharge of a lithium-ion secondary battery including an electrolytic solution according to Example 2;

FIG. 5 is a graph showing cycle characteristics during high-rate discharge of the lithium-ion secondary battery including the electrolytic solution according to Comparative Example 1;

FIG. 6 is a graph showing cycle characteristics during high-rate discharge of the lithium-ion secondary battery including the electrolytic solution according to Comparative Example 2;

FIG. 7 is a graph showing charge/discharge curves during high-rate charge of the lithium-ion secondary battery including the electrolytic solution according to Example 1;

FIG. 8 is a graph showing charge/discharge curves during high-rate charge of the lithium-ion secondary battery including the electrolytic solution according to Comparative Example 1;

FIG. 9 is a graph showing cycle characteristics during high-rate charge of the lithium-ion secondary battery including the electrolytic solution according to Example 1;

FIG. 10 is a graph showing cycle characteristics during high-rate charge of the lithium-ion secondary battery including the electrolytic solution according to Example 2;

FIG. 11 is a graph showing cycle characteristics during high-rate charge of the lithium-ion secondary battery including the electrolytic solution according to Comparative Example 1; and

FIG. 12 is a graph showing cycle characteristics during high-rate charge of the lithium-ion secondary battery including the electrolytic solution according to Comparative Example 2.

### DETAILED DESCRIPTION OF THE INVENTION

Hereinafter, embodiments of the present invention will be described.

### Electrolytic Solution

An electrolytic solution of an embodiment includes magnesium fluoride (MgF₂), lithium salt, a first solvent, and a second solvent. The first solvent has a dielectric constant of less than 10, and the second solvent has a dielectric constant of more than 50. Herein, since solubility of the magnesium fluoride in the first solvent is high, use of the electrolytic solution of this embodiment improves initial capacity and a capacity retention rate of a lithium-ion secondary battery during high-rate charge and during high-rate discharge. This is presumed to be because a uniform SEI coating film is formed on the interface between an electrode and the electrolytic solution during charge and discharge. Herein, magnesium fluoride is presumed to be solvated without being ionized.

On the contrary, metal fluorides other than magnesium fluoride (for example, sodium fluoride (NaF), and calcium fluoride (CaF₂)) have low solubility in the first solvent, and the electrolytic solution may become clouded and show poor reproducibility although the initial capacity and a capacity retention rate of the lithium-ion secondary battery during high-rate charge and during high-rate discharge may be maintained. This is presumed to be because the SEI coating film formed during charge and discharge changes depending on a suspension state.

A volume ratio of the second solvent to a total amount of the first solvent and the second solvent in the electrolytic solution in this embodiment is preferably 6% or more and 12% or less. It is presumed that when the volume ratio of the second solvent to the total amount of the first solvent and the second solvent in the electrolytic solution in this embodiment is 6% or more, a SEI (an organic coating film portion formed of the second solvent) is not likely to drop off, and the capacity retention rate is improved. On the other hand, it is presumed that when the volume ratio of the second solvent to the total amount of the first solvent and the second solvent in the electrolytic solution in this embodiment is 12% or less, a thin organic coating film is formed, and resistance in high-rate operation is reduced.

The content of the magnesium fluoride in the electrolytic solution of this embodiment is preferably 0.3% by mass or more and 1.0% by mass or less, and further preferably 0.3% by mass or more and 0.6% by mass or less. When the content of magnesium fluoride in the electrolytic solution of this embodiment is 0.3% by mass or more, the amount of the second solvent for forming SEI free from defects can be reduced, thus reducing the resistance during high-rate operation. On the contrary, when the content of magnesium fluoride in the electrolytic solution of this embodiment is 1.0% by mass or less, resistance of magnesium fluoride itself can be suppressed, thus improving the initial capacity of the lithium-ion secondary battery. In considering the resistance of magnesium fluoride itself and resistance reduction caused by the effect of reduction of the second solvent amount by addition of magnesium fluoride, comprehensively, it is presumed that the addition amount of the magnesium fluoride capable of reducing the resistance of the SEI is 0.3% by mass or more and 0.6% by mass or less.

The first solvent is not particularly limited as long as it is a solvent having a dielectric constant of less than 10, and, for example, chain carbonate can be used. Examples of the chain carbonate include dimethyl carbonate (DMC), diethyl carbonate (DEC), ethyl methyl carbonate (EMC), and the like, and two or more types may be used in combination.

The second solvent is not particularly limited as long as it is a solvent having a dielectric constant of more than 50, and, for example, cyclic carbonate can be used. Examples of the cyclic carbonate include ethylene carbonate (EC), propylene carbonate (PC), vinylene carbonate (VC), and the like, and two or more types may be used in combination.

The lithium salt is not particularly limited, and examples of the lithium salt include lithium hexafluorophosphate (LiPF₆), lithium tetrafluoroborate (LiBF₄), lithium bis(fluorosulfonyl)imide (LiFSI), and the like, and two or more types may be used in combination.

The electrolytic solution of this embodiment may further include additives such as a thickener.

The thickener is not particularly limited, and examples of the thickener include carboxymethylcellulose (CMC), polyethylene oxide (PEO), polyvinylidene fluoride (PVdF), and the like, and two or more types may be used in combination.

The electrolytic solution of this embodiment may have viscosity of 5000 mPas·or more. This improves handling property in manufacturing the electrolytic solution.

### Lithium-Ion Secondary Battery

A lithium-ion secondary battery of this embodiment includes an electrolytic solution of this embodiment. The lithium-ion secondary battery of this embodiment is not particularly limited, and, for example, the lithium-ion secondary battery includes a positive electrode current collector, a positive electrode material mixture layer, a separator, a negative electrode material mixture layer, a negative electrode current collector, which are stacked sequentially, and in which the separator is filled with an electrolytic solution.

The positive electrode current collector is not particularly limited, and examples of the positive electrode current collector include metal foil such as aluminum foil.

The positive electrode material mixture layer includes a positive electrode active material, and may further include a solid electrolyte, a conductive auxiliary agent, a binding agent, and the like, as necessary.

The positive electrode active material is not particularly limited as long as it is capable of occluding and releasing lithium ions, and examples thereof include LiCoO₂, Li(Ni_{5/10}Co_{2/10}Mn_{3/10})O₂, Li(Ni_{6/10}Co_{2/10}Mn_{2/10}) O₂, Li(Ni_{8/10}Co_{1/10}Mn_{1/10})O₂, Li(Ni_{0.8}Co_{0.1}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, and the like. These positive electrode active materials may be used alone or a plurality of these positive electrode active materials may be used in a mixture.

The negative electrode active material is not particularly limited as long as it is capable of occluding and releasing lithium ions, and examples thereof include metallic lithium, a lithium alloy, metallic oxide, metal sulfide, metal nitride, Si, SiO, carbon material, and the like. These negative electrode active materials may be used alone, or a plurality of these positive electrode active materials may be used in a mixture.

Examples of the carbon materials include artificial graphite, natural graphite, hard carbon soft carbon, and the like.

As the separator, a separator compatible with high rates is preferable so that the separator itself is not great resistance. The structure of the separator is not particularly limited, and examples thereof include microporous sheet-like separators, and the like. The material of the separator is not particularly limited, and examples thereof include polypropylene, and the like.

Note here that the lithium-ion secondary battery of this embodiment can be manufactured by well-known methods.

In the above, an embodiment of the present invention is described, but the present invention is not limited to the embodiment mentioned above, and the embodiment may be modified appropriately within a scope of the gist of the present invention.

### EXAMPLES

Hereinafter, Examples of the present invention will be described, but the present invention is not limited only to these Examples.

### Example 1

LiPF₆ was dissolved in an EC-DMC mixed solvent (EC: 9% by volume) at 1 M, and MgF₂ was then dissolved therein at 0.6% by mass to obtain an electrolytic solution.

### Example 2

LiPF₆ was dissolved in an EC-DMC mixed solvent (EC: 12% by volume) at 1 M, and MgF₂ was then dissolved therein at 0.3% by mass to obtain an electrolytic solution.

### Comparative Example 1

LiPF₆ was dissolved in an EC-DMC mixed solvent (EC: 33% by volume) at 1 M to obtain an electrolytic solution.

### Comparative Example 1

LiPF₆ was dissolved in an EC-DMC mixed solvent (EC: 12% by volume) at 1 M to obtain an electrolytic solution.

### Production of Lithium-Ion Secondary Battery

A separator was filled with the electrolytic solution according to Examples or Comparative Examples to produce a lithium-ion secondary battery having the following configuration.

Positive electrode: 16 mmϕ

Positive electrode current collector: 20 μm-thick Al foil
Positive electrode active material: lithium cobaltate (3 mAh)
Negative electrode: 16 mmϕ
Negative electrode current collector: 20 μm-thick Cu foil
Negative electrode active material: graphite (3.6 mAh)
Separator: microporous polypropylene sheet
The battery was constructed by impregnating the separator with the electrolytic solution in an argon atmosphere, sandwiching the separator between the positive and negative electrodes, and placing the obtained product in a coin-shaped cell.

### High-Rate Discharge

A constant current charge/discharge test of a lithium-ion secondary battery was carried out in the following conditions.

Charge rate: 1 C
Discharge rate: 20 C

### Temperature: 35° C.

Number of cycles: 100 cycles

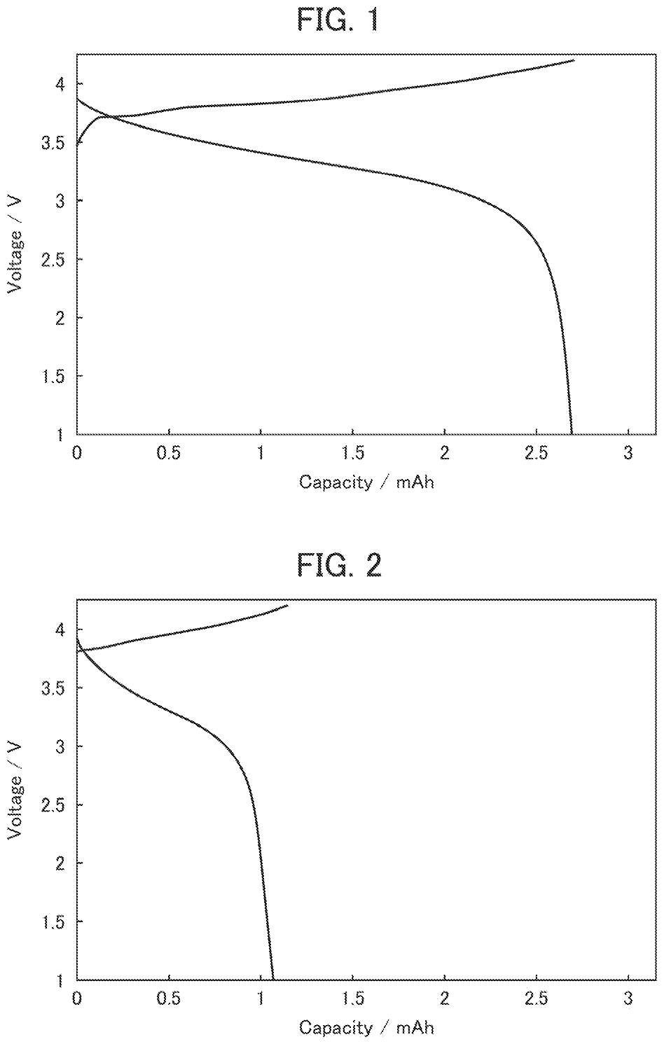

FIGS. 1 and 2 respectively show initial charge/discharge curves during high-rate discharge of lithium-ion secondary batteries including electrolytic solutions according to Example 1 and Comparative Example 1.

From FIGS. 1 and 2, it is shown that when the electrolytic solution according to Example 1 is used, the initial capacity during high-rate discharge of the lithium-ion secondary battery is high. On the contrary, since the electrolytic solution of Comparative Example 1 does not include MgF₂, the initial capacity during high-rate discharge of the lithium-ion secondary battery is low.

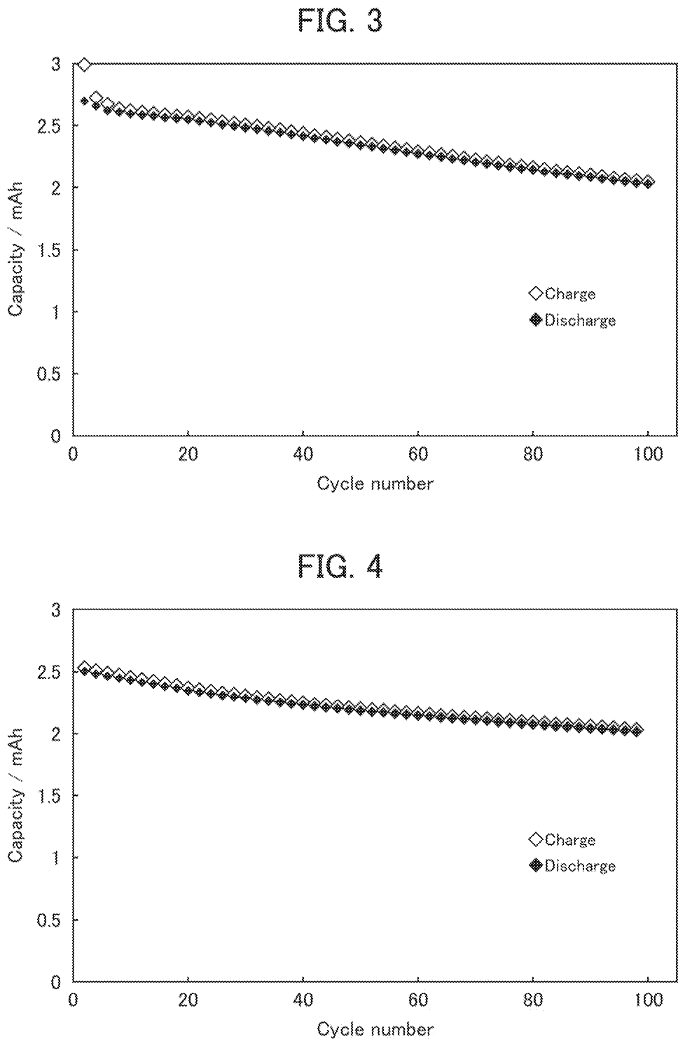

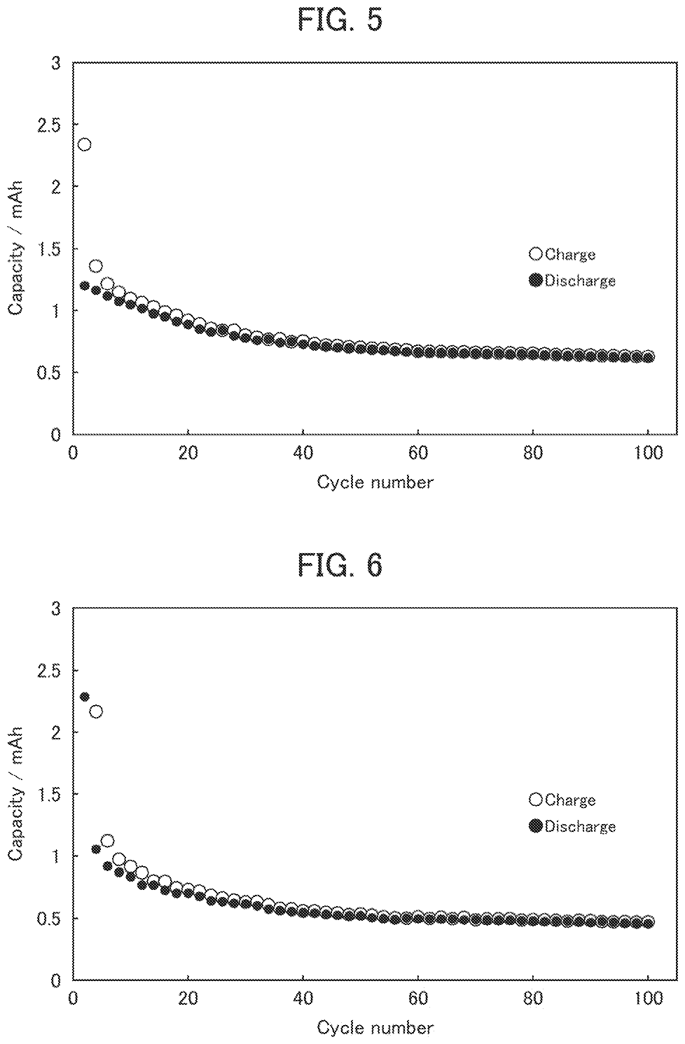

FIGS. 3 to 6 respectively show cycle characteristics during high-rate discharge of lithium-ion secondary batteries including the electrolytic solutions according to Examples 1 and 2 and Comparative Examples 1 and 2.

From FIGS. 3 to 6, it is shown that when the electrolytic solutions according to Examples 1 and 2 are used, the initial capacity and the capacity retention rate of the lithium-ion secondary batteries during high-rate discharge are high. On the contrary, since the electrolytic solutions of Comparative Examples 1 and 2 do not include MgF₂, the initial capacity and the capacity retention rate of the lithium-ion secondary batteries during high-rate discharge are low.

### High-Rate Charge

A constant current charge/discharge test of a lithium-ion secondary battery was carried out in the following conditions.

Charge rate: 10 C
Discharge rate: 1 C

### Temperature: 35° C.

Number of cycles: 100 cycles

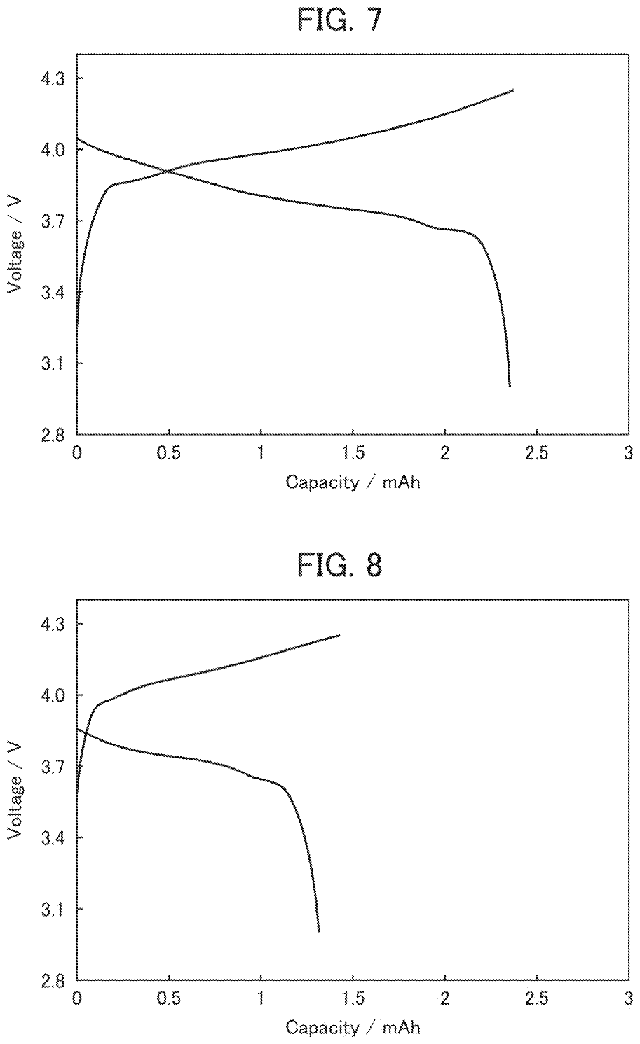

FIGS. 7 and 8 respectively show initial charge/discharge curves during high-rate charge of lithium-ion secondary batteries including electrolytic solutions according to Example 1 and Comparative Example 1.

From FIGS. 7 and 8, it is shown that when the electrolytic solution according to Example 1 is used, the initial capacity during high-rate charge of the lithium-ion secondary battery is high. On the contrary, since the electrolytic solution of Comparative Example 1 does not include MgF₂, the initial capacity during high-rate charge of the lithium-ion secondary battery is low.

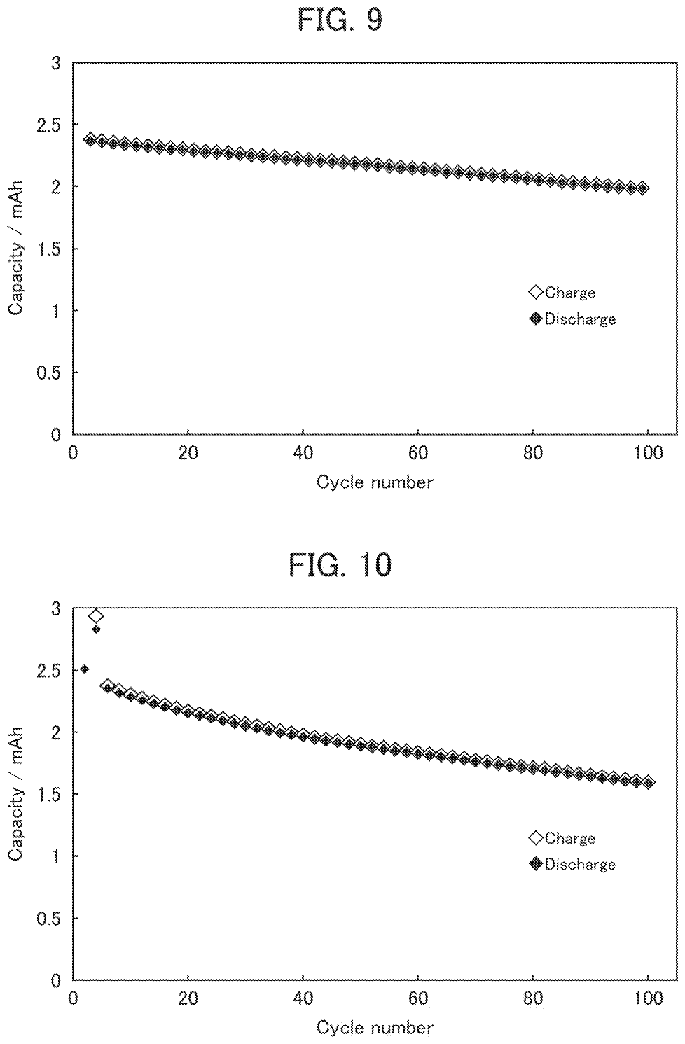

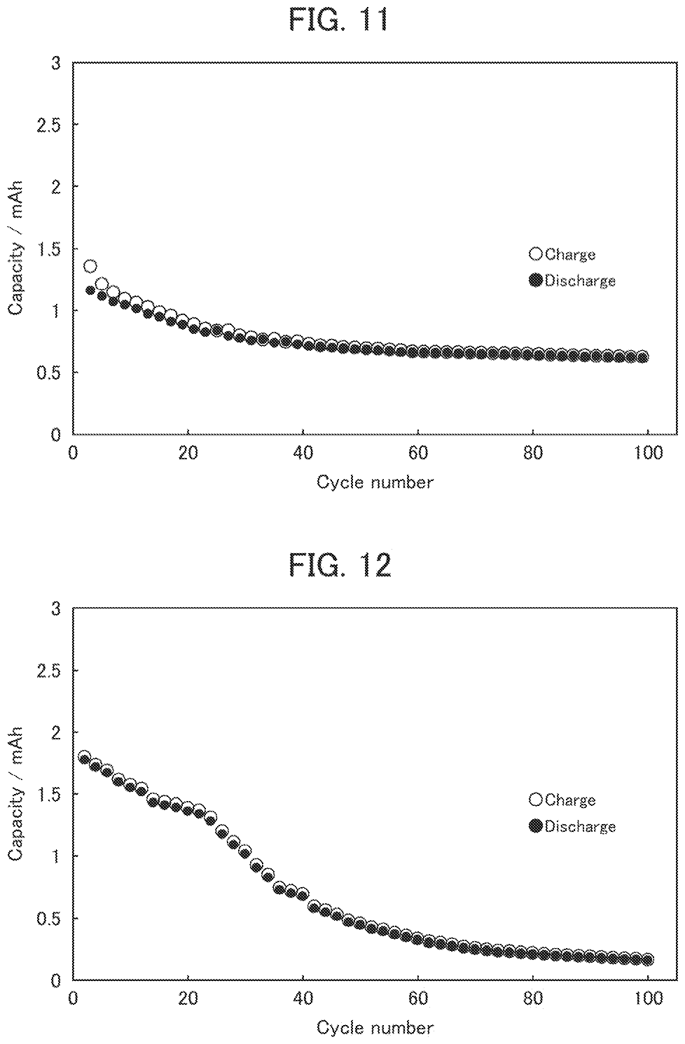

FIGS. 9 to 12 respectively show cycle characteristics during high-rate charge of lithium-ion secondary batteries including the electrolytic solutions according to Examples 1 and 2 and Comparative Examples 1 and 2.

From FIGS. 9 to 12, it is shown that when the electrolytic solutions according to Examples 1 and 2 are used, the initial capacity and the capacity retention rate of the lithium-ion secondary batteries during high-rate charge are high. On the contrary, since the electrolytic solutions of Comparative Examples 1 and 2 do not include MgF₂, the initial capacity and the capacity retention rate of the lithium-ion secondary batteries during high-rate charge are low.

What is claimed is:

1. An electrolytic solution comprising:
magnesium fluoride;
A lithium salt;
a first solvent; and
a second solvent,
the first solvent having a permittivity of less than 10,
the second solvent having a permittivity of more than 50.

2. The electrolytic solution according to claim 1, wherein a volume ratio of the second solvent to a total amount of the first solvent and the second solvent is 6% or more and 12% or less.

3. The electrolytic solution according to claim 1, wherein a content of the magnesium fluoride is 0.3% by mass or more and 1.0% by mass or less.

4. The electrolytic solution according to claim 1, wherein the first solvent is one or more types selected from the group consisting of dimethyl carbonate, diethyl carbonate, and ethyl methyl carbonate.

5. The electrolytic solution according to claim 1, wherein the second solvent is one or more types selected from the group consisting of ethylene carbonate, propylene carbonate, and vinylene carbonate.

6. A lithium-ion secondary battery comprising the electrolytic solution according to claim 1.
